(19) United States
(12) Patent Application Publication
(10) Pub. No.: US 2026/0255350 A1
(43) Pub. Date: Aug. 27, 2026

(54) METHODS AND APPARATUSES OF UCI TRANSMISSION

(71) Applicant: LENOVO (BEIJING) LIMITED, Beijing (CN)

(72) Inventors: Wei LING, Beijing (CN); Yi ZHANG, Beijing (CN); Chenxi ZHU, Fairfax, VA (US); Bingchao LIU, Beijing (CN); Lingling XIAO, Beijing (CN)

(21) Appl. No.: 18/877,448

(22) PCT Filed: Jun. 24, 2022
(86) PCT No.: PCT/CN2022/101170

§ 371 Date: Dec. 20, 2024

(51) Int. Cl. H04W 72/21; H04B 7/06

(52) U.S. Cl. CPC H04W 72/21; H04B 7/0626; H04B 7/06952

(57) ABSTRACT

Embodiments of the present disclosure relate to a method and apparatus for of uplink control information (UCI) transmission. An embodiment of the present disclosure provides a method performed by a UE, which includes: receiving information scheduling or activating a PUSCH, wherein the PUSCH is configured with a plurality of repetitions being frequency multiplexed, and each repetition of the plurality of repetitions is associated with a beam of a plurality of beams; and transmitting UCI on at least one repetition of the plurality of repetitions of the PUSCH transmission, wherein in the case that the UCI is transmitted on at least two repetitions of the plurality of repetitions, a total number of coded bits of the UCI on each of the at least two repetitions is identical.

### TECHNICAL FIELD

Embodiments of the present disclosure relate to wireless communication, and more specifically relate to a method and apparatus of uplink control information (UCI) transmission on physical uplink shared channel (PUSCH).

### BACKGROUND OF THE INVENTION

Multiple panel uplink (UL) transmission based common beam framework will be studied in R18. For single downlink control information (S-DCI) based multiple transmit-receive point (M-TRP) PUSCH, PUSCH transmission may be transmitted from two panels towards two TRPs with frequency-division multiplexing (FDM) manner. In R16, there are two FDM schemes specified for PDSCH, which are FDM scheme A PDSCH and FDM scheme B. The aperiodic or semi-persistent channel state information (CSI) may be transmitted on two time division multiplexed (TDMed) PUSCH repetitions (or occasions) which are associated with two SRS resource sets respectively in R17. However, how to multiplex UCIs on FDMed PUSCH repetitions has not been solved yet.

Therefore, it is desirable to provide a technical solution of UCI transmission on FDMed PUSCH repetitions.

### SUMMARY

An embodiment of the present disclosure provides a user equipment (UE), which includes: a transceiver; and a processor coupled with the transceiver and configured to: receive information scheduling or activating a PUSCH, wherein the PUSCH is configured with a plurality of repetitions being frequency multiplexed, and each repetition of the plurality of repetitions is associated with a beam of a plurality of beams; and transmit UCI on at least one repetition of the plurality of repetitions of the PUSCH transmission, wherein in the case that the UCI is transmitted on at least two repetitions of the plurality of repetitions, a total number of coded bits of the UCI on each of the at least two repetitions is identical.

In some embodiments, in the case that the UCI only includes CSI reporting, the UCI is transmitted on at least two repetitions of the plurality of repetitions.

In some embodiments, in the case that the UCI at least includes a type of UCI different from CSI reporting, the UCI is transmitted on one repetition of the plurality of repetitions as the following: a repetition with a largest number of resource blocks (RB) s among the plurality of repetitions; a repetition with a smallest number of RBs among the plurality of repetitions; a repetition associated with a first beam among the plurality of beams; a repetition associated with a last beam among the plurality of beams; a repetition associated with a lowest starting RB index among the plurality of repetitions; or a repetition associated with a highest starting RB index among the plurality of repetitions.

In some embodiments, the UCI is transmitted on the at least two repetitions of the plurality of repetitions regardless whether CSI reporting is included in the UCI.

In some embodiments, in the case that the UCI is transmitted on at least two repetitions of the plurality of repetitions, the processor is further configured to: determine the total number of coded bits of the UCI of each of the at least two repetitions based on a total number of RBs of each of the at least two repetitions and a total number of phase tracking reference signal (PT-RS) ports of each of the at least two repetitions, wherein the total number of RBs of each repetition of the at least two repetitions is identical, and the total number of PT-RS ports of each repetition of the at least two repetitions is identical.

In some embodiments, in the case that the UCI is transmitted on at least two repetitions of the plurality of repetitions, the processor is further configured to: determine the total number of coded bits of the UCI of each of the at least two repetitions based on a total number of RBs of a repetition of the plurality of repetitions and a total number of PT-RS resource elements (RE) s of a repetition of the plurality of repetitions as the following: a repetition with a largest number of RBs among the plurality of repetitions; a repetition with a smallest number of RBs among the plurality of repetitions; a repetition associated with a first beam among the plurality of beams; a repetition associated with a last beam among the plurality of beams; a repetition associated with a lowest starting RB index among the plurality of repetitions; or a repetition associated with a highest starting RB index among the plurality of repetitions.

Another embodiment of the present disclosure provides a base station (BS), which includes: a transceiver; and a processor coupled with the transceiver and configured to: transmit information scheduling or activating a PUSCH, wherein the PUSCH is configured with a plurality of repetitions being frequency multiplexed, and each repetition of the plurality of repetitions is associated with a beam of a plurality of beams; and receive UCI on at least one repetition of the plurality of repetitions of the PUSCH transmission, wherein in the case that the UCI is received on at least two repetitions of the plurality of repetitions, a total number of coded bits of the UCI on each of the at least two repetitions is identical.

In some embodiments, in the case that the UCI only includes a CSI reporting, the UCI is received on at least two repetitions of the plurality of repetitions.

In some embodiments, in the case that the UCI at least includes a type of UCI different from CSI reporting, the UCI is received on one repetition of the plurality of repetitions as the following: a repetition with a largest number of RBs among the plurality of repetitions; a repetition with a smallest number of RBs among the plurality of repetitions; a repetition associated with a first beam among the plurality of beams; a repetition associated with a last beam among the plurality of beams; a repetition associated with a lowest starting resource block (RB) index among the plurality of repetitions; or a repetition associated with a highest starting RB index among the plurality of repetitions.

In some embodiments, the UCI is received on the at least two repetitions of the plurality of repetitions regardless whether CSI reporting is included in the UCI.

In some embodiments, in the case that the UCI is received on at least two repetitions of the plurality of repetitions, the processor is further configured to: determine the total number of coded bits of the UCI of each of the at least two repetitions based on a total number of RBs of each of the at least two repetitions and a total number of PT-RS ports of each of the at least two repetitions, wherein the total number of RBs of each repetition of the at least two repetitions is identical, and the total number of PT-RS ports of each repetition of the at least two repetitions is identical.

In some embodiments, in the case that the UCI is received on at least two repetitions of the plurality of repetitions, the processor is further configured to: determine the total number of coded bits of the UCI of each of the at least two repetitions based on a total number of RBs of a repetition of the plurality of repetitions and a total number of PT-RS REs of a repetition of the plurality of repetitions as the following: a repetition with a largest number of RBs among the plurality of repetitions; a repetition with a smallest number of RBs among the plurality of repetitions; a repetition associated with a first beam among the plurality of beams; a repetition associated with a last beam among the plurality of beams; a repetition associated with a lowest starting RB index among the plurality of repetitions; or a repetition associated with a highest starting RB index among the plurality of repetitions.

Yet another embodiment of the present disclosure provides a method performed by a UE, which includes: receiving information scheduling or activating a PUSCH, wherein the PUSCH is configured with a plurality of repetitions being frequency multiplexed, and each repetition of the plurality of repetitions is associated with a beam of a plurality of beams; and transmitting UCI on at least one repetition of the plurality of repetitions of the PUSCH transmission, wherein in the case that the UCI is transmitted on at least two repetitions of the plurality of repetitions, a total number of coded bits of the UCI on each of the at least two repetitions is identical.

Still another embodiment of the present disclosure provides a method performed by a BS, which includes: transmitting information scheduling or activating a PUSCH, wherein the PUSCH is configured with a plurality of repetitions being frequency multiplexed, and each repetition of the plurality of repetitions is associated with a beam of a plurality of beams; and receiving UCI on at least one repetition of the plurality of repetitions of the PUSCH transmission, wherein in the case that the UCI is received on at least two repetitions of the plurality of repetitions, a total number of coded bits of the UCI on each of the at least two repetitions is identical.

### BRIEF DESCRIPTION OF THE DRAWINGS

In order to describe the manner in which advantages and features of the present disclosure can be obtained, a description of the present disclosure is rendered by reference to specific embodiments thereof, which are illustrated in the appended drawings. These drawings depict only example embodiments of the present disclosure and are not therefore to be considered limiting of its scope.

FIG. 1 illustrates a schematic diagram of a wireless communication system according to some embodiments of the present disclosure.

FIG. 2 illustrates a flow chart of a method of UCI transmission performed by a UE according to some embodiments of the present disclosure.

FIG. 3 illustrates a flow chart of a method of UCI transmission performed by a BS according to some embodiments of the present disclosure.

FIG. 4 illustrates a simplified block diagram of an exemplary apparatus of UCI transmission according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

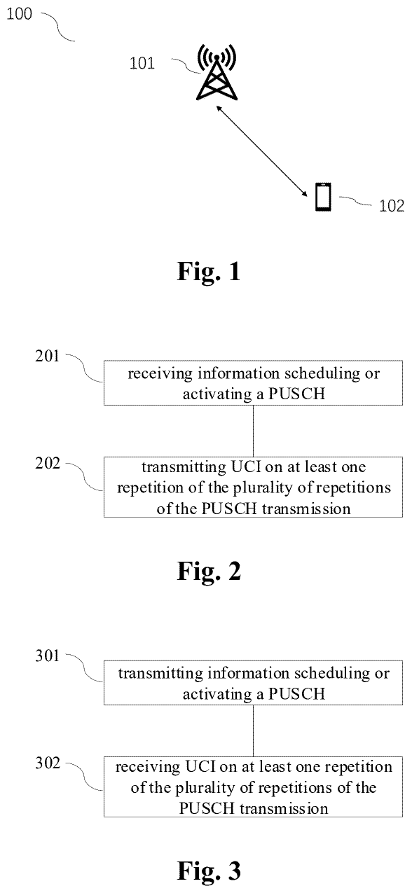

FIG. 1 illustrates a schematic diagram of an exemplary wireless communication system according to some embodiments of the present disclosure.

As shown in FIG. 1, the wireless communication system 100 includes a UE 102 and a BS 101. Although merely one BS is illustrated in FIG. 1 for simplicity, it is contemplated that the wireless communication system 100 may include more BSs in some other embodiments of the present disclosure. Similarly, although merely one UE is illustrated in FIG. 1 for simplicity, it is contemplated that the wireless communication system 100 may include more UEs in some other embodiments of the present disclosure.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101. Furthermore, the BS 101 may be configured with one TRP (or panel) or more TRPs (or panels). A TRP can act like a small BS.

In a wireless communication system, a single TRP can be used to serve one or more UEs under control of a BS. In different scenarios, TRP may be referred to as different terms. Persons skilled in the art should understand that as the 3rd generation partnership project (3GPP) and the communication technology develop, the terminologies recited in the specification may change, which should not affect the scope of the present disclosure. It should be understood that the TRP(s) (or panel(s)) configured for the BS may be transparent to a UE.

The UE 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 102 may include wearable devices, such as smart watches, fitness bands, optical head-mounted displays, or the like. Moreover, the UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, a long term evolution (LTE) network, a 3GPP-based network, a 3GPP 5G network, a satellite communications network, a high-altitude platform network, and/or other communications networks.

In one embodiment, the wireless communication system 100 is compatible with the 5G new radio (NR) of the 3GPP protocol, wherein the BS 102 transmits data using an orthogonal frequency division multiplexing (OFDM) modulation scheme on the downlink and the UE 102 transmits data on the uplink using a single-carrier frequency division multiple access (SC-FDMA) or OFDM scheme. More generally, the wireless communication system 100 may implement some other open or proprietary communication protocols, for example, WiMAX, among other protocols.

In other embodiments, the BS 101 may communicate using other communication protocols, such as the IEEE 802.11 family of wireless communication protocols. Further, in some embodiments, the BS 101 may communicate over licensed spectrums, whereas in other embodiments the BS 101 may communicate over unlicensed spectrums. The present disclosure is not intended to be limited to the implementation of any particular wireless communication system architecture or protocol. In another embodiment, the BS 101 may communicate with the UE 102 using the 3GPP 5G protocols.

There is a work item description (WID) approved on multi-input multi-output (MIMO) in NR R18 which includes the research topic as following:
Specify extension of Rel-17 unified transmission configuration indication (TCI) framework for indication of multiple downlink (DL) and UL TCI states focusing on multi-TRP use case, using Rel-17 unified TCI framework.
Study, and if needed, specify the following items to facilitate simultaneous multi-panel UL transmission for higher UL throughput/reliability, focusing on FR2 and multi-TRP, assuming up to 2 TRPs and up to 2 panels, targeting customer premise equipment (CPE)/fixed wireless access (FWA)/vehicle/industrial devices (if applicable)
   UL precoding indication for PUSCH, where no new codebook is introduced for multi-panel simultaneous transmission
      The total number of layers is up to four across all panels and total number of codewords is up to two across all panels, considering single DCI and multi-DCI based multi-TRP operation.
   UL beam indication for PUCCH/PUSCH, where unified TCI framework extension in objective 2 is assumed, considering single DCI and multi-DCI based multi-TRP operation.
   For the case of multi-DCI based multi-TRP operation, only PUSCH and PUSCH, or PUCCH and PUCCH is transmitted across two panels in the same component carrier (CC).

It is noted that multiple panel UL transmission based common beam framework will be studied in R18. For S-DCI based M-TRP PUSCH, PUSCH transmission can be transmitted from two panels towards two TRPs with a FDM manner. In R16, there are two FDM schemes specified for PDSCH, which includes FDM scheme A and FDM scheme B.

The repetition scheme of a UE may be configured by a higher layer parameter, e.g. “repetitionScheme,” and the parameter may be set to “fdmSchemeB”, i.e. the repetition scheme is FDM Scheme B. In this case, when two TCI states are indicated in the DCI and repetition scheme of the UE is set to “fdmSchemeB”, the UE may receive two PDSCH transmission occasions (or repetitions) of the same transport block (TB) with each TCI state being associated with a PDSCH transmission occasion which has non-overlapping frequency domain resource allocation with respect to the other PDSCH transmission occasion.

Similar to PDSCH, FDM scheme A and FDM scheme B may also applied to PUSCH. Persons skilled in the art should well know that FDM scheme A and FDM scheme B are only FDM scheme names, which may change as the evolution of 3GPP specification, and thus should be not used to unduly limit the protection scope of the present disclosure. Embodiments of the present disclosure focus on the PUSCH transmission with FDM scheme B. In some scenarios, two PUSCH transmission occasions with the same or different redundancy versions (RVs) of the same TB may be transmitted from different UE panels on non-overlapped frequency domain resources and the same time domain resources. In some other scenarios, more than two PUSCH transmission occasions with the same or different RVs of the same TB may be transmitted from different UE panels on non-overlapped frequency domain resources and the same time domain resources.

The UCI, such as aperiodic or semi-persistent CSI reporting, may be transmitted on at least two FDMed PUSCH repetitions which are associated with at least two SRS resource sets respectively. In other words, the UCI may be multiplexed on the PUSCH, wherein the PUSCH may be configured with at least two repetitions of a plurality of repetitions, and the at least two repetitions may be frequency multiplexed, e.g., with the FDM scheme B, and each repetition of the at least two repetitions of the plurality of repetitions may be associated with a beam of a plurality of beams. When the UCI is transmitted on at least two repetitions of the plurality of repetitions (or on at least two PUSCH transmission occasions), the total number of coded bits of the UCI on each of the at least two repetitions are identical according to some embodiments of the present disclosure. Since modulation and layer number of each repetitions of FDM PUSCH transmission are the same, therefore, the coded modulation symbols per layer of the UCI on each of the at least two repetitions are identical since the coded bits of UCI on each of the at least two repetitions are determined according to the coded modulation symbols per layer of the UCI, the modulation and the layer number.

There may be different types of UCI multiplexed with PUSCH, for example, some types of UCI transmission are presented as follows:
Hybrid automatic repeat request acknowledgement (HARQ-ACK) transmission on a PUSCH with uplink shared channel (UL-SCH);
HARQ-ACK transmission on a PUSCH without UL-SCH;
CSI transmission on a PUSCH with UL-SCH, and
CSI transmission on a PUSCH without UL-SCH.

For the above different types of UCI, according to the 3GPP documents (for example, TS 38. 212), the total number of coded bits of the UCI on a repetition may be calculated as follows.

For HARQ-ACK transmission on a PUSCH with UL-SCH, the number of coded modulation symbols per layer for HARQ-ACK transmission, which may be denoted as

$${Q}_{ACK}^{′}$$

as determined as follows:

$${Q}_{ACK}^{′} = min \{ ⌈ \frac{\begin{matrix}( {O}_{ACK} + {L}_{ACK} ) \cdot {β}_{offset}^{PUSCH} \cdot \\ {\sum }_{l = 0}^{{N}_{symb , all}^{PUSCH} - 1} {M}_{sc}^{UCI} ( l )\end{matrix}}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \}$$

Wherein the parameter

$${M}_{sc}^{UCI} ( l )$$

is the number of REs that can be used for transmission of UCI in OFDM symbol l, for

$$l = 0 , 1 , 2 , … , {N}_{symb , all}^{PUSCH} - 1 ,$$

in the PUSCH transmission. The parameter

$${N}_{symb , all}^{PUSCH}$$

is the total number of OFDM symbols of the PUSCH, including all OFDM symbols used for DMRS. The other parameters are the same for each repetition of the at least two repetitions of the plurality of repetitions, thus the detailed meaning of other parameters are omitted here, and persons skilled in the art may refer to the 3GPP documents (e.g. TS38.212) for details.

For HARQ-ACK transmission on a PUSCH without UL-SCH, the number of coded modulation symbols per layer for HARQ-ACK transmission, which may be denoted as denoted as

$${Q}_{ACK}^{′} ,$$

is determined as follows:

$${Q}_{ACK}^{′} = min \{ ⌈ \frac{( {O}_{ACK} + {L}_{ACK} ) \cdot {β}_{offset}^{PUSCH}}{R \cdot {Q}_{m}} ⌉ , ⌈ α \cdot {\sum }_{l = {l}_{0}}^{{N}_{symb , all}^{PUSCH} - 1} {M}_{sc}^{UCI} ( l ) ⌉ \}$$

The parameter,

$${M}_{sc}^{UCI} ( l ) ,$$

is also included in the above formula and the detailed meanings of other parameters are omitted here.

The CSI report may include CSI part 1 and/or CSI part 2, and the number of coded modulation symbols per layer for CSI part 1 or 2 is specified in the 3GPP documents shown as follows.

For CSI part 1 transmission on PUSCH with UL-SCH, the number of coded modulation symbols per layer for CSI part 1 transmission, which may be denoted as

$${Q}_{CSI - part 1}^{, ′} ,$$

is determined as follows:

$${Q}_{CSI - 1}^{′} = min \{ ⌈ \frac{\begin{matrix}( {O}_{CSI - 1} + {L}_{CSI - 1} ) \cdot {β}_{offset}^{PUSCH} \cdot \\ {\sum }_{l = 0}^{{N}_{symb , all}^{PUSCH} - 1} {M}_{sc}^{UCI} ( l )\end{matrix}}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$$

The parameter,

$${M}_{sc}^{UCI} ( l ) ,$$

is also included in the above formula, and the detailed meanings of other parameters are omitted here.

For CSI part 1 transmission on PUSCH without UL-SCH, the number of coded modulation symbols per layer for CSI part 1 transmission, which may be denoted as

$${Q}_{CSI - part 1}^{′} ,$$

is determined as follows:
if there is CSI part 2 to be transmitted on the PUSCH,

$${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$$

$$else$$

$${Q}_{CSI - 1}^{′} {\sum }_{l = 0}^{{N}_{symb , all}^{PUSCH} - 1} {M}_{sc}^{UCI} ( l ) - {Q}_{ACK}^{′}$$

$$end if$$

The parameter,

$${M}_{sc}^{UCI} ( l ) ,$$

is also included in the above formula, and the detailed meanings of other parameters are omitted here.

For CSI part 1 transmission on PUSCH with UL-SCH, the number of coded modulation symbols per layer for CSI part 2 transmission, which may be denoted as

$${Q}_{CSI - part 2}^{′} ,$$

is determined as follows:

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$$

The parameter,

$${M}_{sc}^{UCI} ( l ) ,$$

is also included in the above formula, and the detailed meanings of other parameters are omitted here.

According to the above formulas for calculating the number of coded modulation symbols per layer of the UCI for a repetition, all the parameters except for the parameter:

$${M}_{sc}^{UCI} ( l ) ,$$

which is the available RE number for UCI of each symbol of a PUSCH, are the same. Therefore, in order to make sure the total number of coded bits of the UCI on each repetition of the at least two repetitions of the plurality of repetitions is the same, the parameter

$${M}_{sc}^{UCI} ( l ) ,$$

of the at least two repetitions of the plurality of repetitions should be identical.

The parameter

$${M}_{sc}^{UCI} ( l ) ,$$

is calculated as follows:
for any OFDM symbol that carries DMRS of the PUSCH,

$${M}_{sc}^{UCI} ( l ) = 0 ;$$

for any OFDM symbol that does not carry DMRS of the PUSCH,

$${M}_{sc}^{UCI} ( l ) = {M}_{sc}^{PUSCH} - {M}_{sc}^{PT - RS} ( l ) .$$

The parameter,

$${M}_{sc}^{PUSCH} ,$$

which is the scheduled bandwidth of the PUSCH transmission, expressed as a number of subcarriers, is determined by the number of RBs of each repetition. The parameter,

$${M}_{sc}^{PT - RS} ( l ) ,$$

which is the number of subcarriers in OFDM symbol l that carries the PTRS, in the PUSCH transmission, is determined by the number of symbols, the number of RB number and the number of PT-RS port of each repetition.

However, the number of RBs of the two or more PUSCH transmission occasions of FDM Scheme B may be different considering the RB assignment scheme of two or more PUSCH transmission occasions of FDM Scheme B. Besides, it is possible that the numbers of PT-RS REs of the two or more PUSCH transmission occasions are different considering the possible different PT-RS port number of two or more PUSCH transmission occasions of FDM Scheme B and the possible different PT-RS density of two or more PUSCH transmission occasions. Therefore, how to ensure coded UCI bits identical on two PUSCH repetitions of FDM Scheme B needs to be enhanced.

Embodiments of the present disclosure propose a technical solution of UCI transmission, e.g., including technical solutions of multiplexing the UCI on at least two PUSCH repetitions.

Hereinafter, the plurality of PUSCH repetitions are frequency multiplexed, and the frequency multiplexing mode may be referred to as the FDM Scheme B or other name. These PUSCH repetitions may also be referred to as repetitions, FDMed PUSCH repetitions, FDMed repetitions, or the like.

In addition, a common beam framework may be applied for PUSCH transmission. Two beams, which (correspond to two SRS resource sets may be two joint or UL common beams, e.g., indicated by DCI with a MAC CE. Alternatively, only a MAC CE to indicate two joint or UL common beams may be applied for the PUSCH transmission with FDM Scheme B. Two SRS resource sets may be configured for codebook or non-codebook based PUSCH transmission. The first SRS resource set of the two SRS resource sets is the SRS resource set with a lower ID (identity or index) and the second SRS resource set of the second SRS resource sets is the SRS resource set with a higher ID. For example, the first SRS resource set may have an ID “0,” the second SRS resource set may have an ID “1.” In some other cases, more than two, for example, three beams (or SRS resource sets) may be configured for codebook or non-codebook based PUSCH transmission. The first beam of the three beams may be with the lowest ID, the second beam is with an ID higher than that of the first beam, and the third beam is with the highest ID. For other numbers of beams, they may be numbered in a similar fashion.

The frequency domain resource assignment (FDRA) of a PUSCH configured with FDM Scheme B is the same as the PUSCH transmission without any repetition scheme.

Regarding the numbers of RBs of the two FDMed PUSCH repetitions, it may be referred to as N₁ and N₂, according to the RB allocation scheme for the two FDMed PUSCH repetitions. The number of RB of one PUSCH repetition may be the same, or close to the same of that of the other PUSCH repetition. That is, N₁ may equal to N₂, or may be close to equal to N₂. The total number of RBs of the two FDMed PUSCH repetitions, i.e. N₁ plus N₂, may be indicated by the FDRA for the PUSCH with FDM Scheme B.

Regarding the transport block size (TBS) of the two PUSCH repetitions with FDM Scheme B, it may be referred to as TBS₁ and TBS₂. The two TBSs are the same due to being determined by available REs of one repetition of the PUSCH with FDM Scheme B. That is, TBS 1=TBS₂.

Besides, the modulation of the two PUSCH repetitions with FDM scheme B should be the same.

The frequency diversity of PT-RS of a PUSCH repetition is according to the scheduled RB number of the repetition according to the following table.

### Frequency Density of PT-RS as a Function of Scheduled Bandwidth

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

According to the above table, when the scheduled bandwidth, i.e. the number of scheduled RBs (N_{RB}), is less than a number, i.e. N_{RB0}, the UE shall assume no PT-RS is present. When the number of scheduled RBs (N_{RB}) is larger than or equal to a number, i.e. N_{RB0}, and is less than another number, i.e. N_{RB1}, the UE shall assume that the frequency density, K_{PT-RS}, is 2. When the number of scheduled RBs (N_{RB}) is larger than or equal to a number, i.e. N_{RB1}, the UE shall assume that the frequency density, K_{PT-RS}, is 4.

Because the frequency diversity of PT-RS of a PUSCH repetition is based on the number of the scheduled RBs of the repetition which may be different for different repetitions, while the time diversity of PT-RS of a PUSCH repetition is based on the number of OFDM symbols which are always the same for different repetitions, regarding the PT-RS REs of each repetition of the at least two repetitions of the plurality of repetitions, the REs are determined by the PT-RS ports associated with each repetition; and the total RB number of each repetitions.

If UCI is to be transmitted on a PUSCH with FDM scheme B, for example, aperiodic CSI report(s) is scheduled on the PUSCH with transport block by a “CSI request” field on DCI of the PUSCH with scheme B, or aperiodic CSI report(s) is scheduled or semi-persistent CSI report(s) is activated on PUSCH with no transport block by a “CSI request” field on a DCI of the PUSCH with Scheme B, the UCI can be transmitted repeatedly on two FDMed repetitions of the PUSCH.

In some embodiments, the UCI may be multiplexed on a PUSCH, and the PUSCH is configured with a plurality of repetitions with FDM Scheme B. In the case that the UCI only includes the CSI reporting (or may be referred to as CSI report(s)), the UCI may be transmitted on at least two repetitions of the plurality of repetitions. And the at least two repetitions of the plurality of repetitions are associated with two different beams. In the case that the UCI includes a type of UCI different from CSI reporting, for example, HARQ-ACK, the UCI may be transmitted only on one repetition of the plurality of repetitions.

In some other embodiments, the UCI may always be transmitted on at least two repetitions of the plurality of repetitions. That is, all types of UCI, such as the CSI only, HARQ-ACK only, CSI and HARQ-ACK together, are all transmitted on at least two repetitions of the plurality of repetitions where the at least two repetitions of the plurality of repetitions are associated with two different beams.
Case 1: the UCI may be transmitted on one repetition of the plurality of repetitions.

In this case, the UCI at least includes a type of UCI different from CSI reporting. And the repetition on which the UCI may be transmitted, may be one of the following:
1. a repetition with the largest (or larger) number of RBs among the plurality of repetitions;
2. a repetition with the smallest (or smaller) RBs among the plurality of repetitions;
3. a repetition associated with the first beam among the plurality of beams;
4. a repetition associated with the last beam among the plurality of beams;
5. a repetition associated with the lowest (or lower) starting RB index among the plurality of repetitions; or
6. a repetition associated with the highest (or higher) starting RB index among the plurality of repetitions.

For example, the plurality of repetitions include two repetitions, the first repetition may include M₁ RBs, which may have the RB index from 0 to M₁−1, the second repetition may include M₂ RBs, which may have the RB index from M₁ to M₁+M₂−1, and M₁<M₂. The plurality of beams includes two beams, the first repetition is associated with the first beam, and the second repetition is associated with the second beam.

According to the above item 1, the UCI may be transmitted on the second repetition because the second repetition has with a larger number of RBs, M₂. According to the above item 2, the UCI may be transmitted on the first repetition since the first repetition has with a smaller number of RBs, M₁. According to the above item 3, the UCI may be transmitted on the first repetition since the first repetition is associated with the first beam among the plurality of beams. According to the above item 4, the UCI may be transmitted on the second repetition since the second repetition is associated with the last beam among the plurality of beams. According to the above item 5, the UCI may be transmitted on the first repetition since the first repetition is associated with the lower starting RB index, i.e. 0, among the plurality of repetitions. According to the above item 6, the UCI may be transmitted on the second repetition because the second repetition is associated with the higher starting RB index, i.e. M₁, among the plurality of repetitions.

After determining one repetition for the UCI, the UE may transmit the UCI on the determined repetition.
Case 2: the UCI may be transmitted on at least two repetitions of the plurality of repetitions. In this case, the UCI may only include CSI reporting, or the UCI is configured to always be transmitted on at least two repetitions of the plurality of repetitions.

In the case that the UCI may be transmitted on at least two repetitions of the plurality of repetitions, some embodiments of the present disclosure propose several solutions for ensuring the total number of coded bits of the UCI on each repetition of the at least two repetitions are the same, so that the UCI can be transmitted repeatedly on two repetitions of the PUSCH with Scheme B.

### Solution 1:

The number of RBs of each repetition of the at least two repetitions of the plurality of repetitions and the number of PT-RS ports of each repetition will be considered as follows.

Regarding the number of RBs of each repetition of the at least two repetitions of the plurality of repetitions, the BS may indicate the total number of RBs by the FDRA of the PUSCH. At UE side, the UE may not expect the number of RBs of each repetition of the at least two repetitions of the plurality of repetitions is different. In other words UE may expect the number of RBs of each repetition is the same. It means that the assigned number of RBs of each repetition should be same.

In the case that the UCI may be transmitted on two repetitions, and the total number of RBs is N_{RB}, the first

$$⌈ \frac{{N}_{RB}}{2} ⌉$$

RBs may be assigned for the first repetition, and the remaining

$$⌊ \frac{{N}_{RB}}{2} ⌋$$

RBs are assigned for the second repetitions. Therefore, the BS may indicate the total number of RBs to be an even number, such that the value

$$⌈ \frac{{N}_{RB}}{2} ⌉$$

is equal to

$$⌊ \frac{{N}_{RB}}{2} ⌋ .$$

In this way, the number of RBs of each repetition of the two is equal to repetitions is the same.

Similarly, in the case the UCI may be transmitted on three repetitions, the first

$$⌊ \frac{{N}_{RB}}{3} ⌋$$

RBs may be assigned for the first repetition, the next

$$⌊ \frac{{N}_{RB}}{3} ⌋$$

RBs may be assigned for the second repetition, and the last

$${N}_{RB} - 2 \times ⌊ \frac{{N}_{RB}}{3} ⌋$$

RBS may be assigned for the third repetition. The BS may indicate a total number of RBs divisible by 3, such that the value

$$⌊ \frac{{N}_{RB}}{3} ⌋$$

is equal to

$${N}_{RB} - 2 \times ⌊ \frac{{N}_{RB}}{3} ⌋ .$$

In this way, the number of RBs of each repetition of the three repetitions is the same.

In the case that the UCI may be transmitted on X repetitions, the first

$$⌊ \frac{{N}_{RB}}{X} ⌋$$

RBs may be assigned for the first repetition, the next

$$⌊ \frac{{N}_{RB}}{X} ⌋$$

RBs may be assigned for the second repetition, . . . , and the last

$${N}_{RB} - ( X - 1 ) \times ⌊ \frac{{N}_{RB}}{X} ⌋$$

KBs may be assigned for the X^{th} repetition. The BS may indicate a total number of RBs divisible by X, such that the value

$$⌊ \frac{{N}_{RB}}{X} ⌋$$

is equal to

$${N}_{RB} - ( X - 1 ) \times ⌊ \frac{{N}_{RB}}{X} ⌋ .$$

In this way, the number of RBs of each repetition of the X repetitions is the same.

Accordingly, since the number of RBs of each repetition is the same, the parameter,

$${M}_{sc}^{PUSCH} ,$$

which is determined by the number of RBs of each repetition, is the same for each repetition.

Regarding the number of PT-RS ports of each repetition, it may be different dependent on different PUSCH. For non-codebook based PUSCH, the PT-RS port number is determined by the SRS resource indicator (SRI). For codebook based PUSCH, the number of PT-RS ports of each repetition is determined by the transmission precoding matrix index (TPMI).

The BS may transmit the DCI of the PUSCH to the UE, in which the SRI or TPMI may be configured to ensure that the number of PT-RS ports of each repetition is identical. At the UE side, the UE may not expect the number of PT-RS ports of each repetition is different, or the UE may expect the number of PT-RS ports of each repetition is same. In other words, the number of PT-RS ports of each repetition should be same. Based on the SRI or TPMI in the DCI, the UE may determine the number of PT-RS ports of each repetition is the same.

Accordingly, since the number of symbols, the number of RB number, and the number of PT-RS port of each repetition is the same, the parameter,

$${M}_{sc}^{PT - RS} ( l ) ,$$

in the same for each repetition.

Based on the formula, i.e.

$${M}_{sc}^{UCI} ( l ) = {M}_{sc}^{PUSCH} - {M}_{sc}^{PT - RS} ( l ) ,$$

the parameter

$${M}_{sc}^{UCI} ( l ) ,$$

modulation and layer number are identical for each repetitions, therefore the total number of coded bits of the UCI on each of the at least two repetitions may be identical, and the UCI (e.g. the CSI) may be transmitted repeatedly on the two repetitions of the PUSCH with FDM scheme B.

### Solution 2:

In this solution, the UE may determine the total number of coded bits of the UCI of each of at least two repetitions of the plurality of repetitions based on a total number of RBs of a specific repetition of the plurality of repetitions and a total number of PT-RS REs of the specific repetition of the plurality of repetitions. For example, the specific repetition may be referred to as Repetition A.

Specifically, the parameter,

$${M}_{sc}^{PUSCH} ,$$

which is determined by the number of RBs of Repetition A. The parameter,

$${M}_{sc}^{PT - RS} ( l ) ,$$

is determined by the number of symbols, the number of RB number and the number of PT-RS port of Repetition A.

Repetition A may be one of the following:
a repetition with the largest (or larger) number of RBs among the plurality of repetitions;
a repetition with the smallest (or smaller) RBs among the plurality of repetitions;
a repetition associated with the first beam among the plurality of beams;
a repetition associated with the last beam among the plurality of beams;
a repetition associated with the lowest (or lower) starting RB index among the plurality of repetitions; or
a repetition associated with the highest (or higher) starting RB index among the plurality of repetitions.

In this way, the total number of coded bits of the UCI on each of the at least two repetitions of the plurality of repetitions, which is calculated based on the corresponding parameters of Repetition A, is identical, and the UCI (e.g. the CSI) may be transmitted repeatedly on the at least two repetitions of the PUSCH with FDM scheme B.

FIG. 2 illustrates a flow chart of a method of UCI transmission performed by a UE according to some embodiments of the present disclosure. The method may be performed by UE 102 as illustrated and shown in FIG. 1.

In the exemplary method shown in FIG. 2, in operation 201, the UE, e.g., a UE 102 as shown in FIG. 1 may receive information scheduling or activating a PUSCH, wherein the PUSCH is configured with a plurality of repetitions being frequency multiplexed, and each repetition of the plurality of repetitions is associated with a beam of a plurality of beams. In operation 202, the UE may transmit UCI on at least one repetition of the plurality of repetitions of the PUSCH transmission, wherein in the case that the UCI is transmitted on at least two repetitions of the plurality of repetitions, a total number of coded bits of the UCI on each of the at least two repetitions is identical.

For example, the UE may receive the DCI which schedules a PUSCH, which is configured with two repetitions with the FDM scheme B, and each repetition is associated with a beam, or, associated with a SRS resource set. The total number of coded bits of the UCI on each of the two repetitions is identical.

In some embodiments, in the case that the UCI only includes CSI reporting, the UCI is transmitted on at least two repetitions of the plurality of repetitions.

In some embodiments, in the case that the UCI at least includes a type of UCI different from CSI reporting, the UCI is transmitted on one repetition of the plurality of repetitions as the following:
a repetition with a largest number of RBs among the plurality of repetitions;
a repetition with a smallest number of RBs among the plurality of repetitions;
a repetition associated with a first beam among the plurality of beams;
a repetition associated with a last beam among the plurality of beams;
a repetition associated with a lowest starting RB index among the plurality of repetitions; or
a repetition associated with a highest starting RB index among the plurality of repetitions.

In some embodiments, the UCI is transmitted on the at least two repetitions of the plurality of repetitions regardless whether CSI reporting is included in the UCI.

In some embodiments, in the case that the UCI is transmitted on at least two repetitions of the plurality of repetitions, the UE is further configured to: determine the total number of coded bits of the UCI of each of the at least two repetitions based on a total number of RBs of each of the at least two repetitions and a total number of PT-RS ports of each of the at least two repetitions, wherein the total number of RBs of each repetition of the at least two repetitions is identical, and the total number of PT-RS ports of each repetition of the at least two repetitions is identical.

In some embodiments, in the case that the UCI is transmitted on at least two repetitions of the plurality of repetitions, the UE is further configured to: determine the total number of coded bits of the UCI of each of the at least two repetitions based on a total number of RBs of a repetition of the plurality of repetitions and a total number of PT-RS REs of a repetition of the plurality of repetitions as the following:
a repetition with a largest number of RBs among the plurality of repetitions;
a repetition with a smallest number of RBs among the plurality of repetitions;
a repetition associated with a first beam among the plurality of beams;
a repetition associated with a last beam among the plurality of beams;
a repetition associated with a lowest starting RB index among the plurality of repetitions; or
a repetition associated with a highest starting RB index among the plurality of repetitions.

FIG. 3 illustrates a flow chart of a method of UCI transmission performed by a BS according to some embodiments of the present disclosure. The method may be performed by BS 101 as illustrated and shown in FIG. 1.

In the exemplary method shown in FIG. 3, in operation 301, the BS, may transmit information scheduling or activating a PUSCH, wherein the PUSCH is configured with a plurality of repetitions being frequency multiplexed, and each repetition of the plurality of repetitions is associated with a beam of a plurality of beams. In operation 302, the BS may receive uplink control information (UCI) on at least one repetition of the plurality of repetitions of the PUSCH transmission, wherein in the case that the UCI is received on at least two repetitions of the plurality of repetitions, a total number of coded bits of the UCI on each of the at least two repetitions is identical.

For example, the BS may transmit the DCI which schedules a PUSCH, which is configured with two repetitions with the FDM scheme B, and each repetition is associated with a beam, or, associated with a SRS resource set. The total number of coded bits of the UCI on each of the two repetitions is identical.

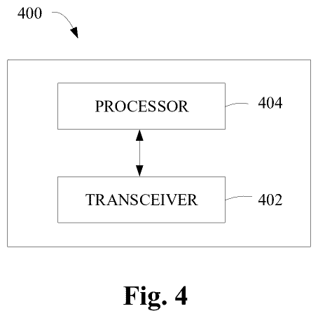

FIG. 4 illustrates a simplified block diagram of an exemplary apparatus of UCI transmission according to some embodiments of the present disclosure.

As shown in FIG. 4, an example of the apparatus 400 may include at least one processor 404 and at least one transceiver 402 coupled to the processor 404. The apparatus 400 may be a UE, a BS, a RAN node, a MN, an SN, or any other device with similar functions.

Although in this figure, elements such as the at least one transceiver 402 and processor 404 are described in the singular, the plural is contemplated unless a limitation to the singular is explicitly stated. In some embodiments of the present disclosure, the transceiver 402 may be divided into two devices, such as a receiving circuitry and a transmitting circuitry. In some embodiments of the present disclosure, the apparatus 400 may further include an input device, a memory, and/or other components.

In some embodiments of the present disclosure, the apparatus 400 may be a UE. The transceiver 402 and the processor 404 may interact with each other so as to perform the operations of the UE described in any of FIGS. 1-3. In some embodiments of the present disclosure, the apparatus 400 may be a node. The transceiver 402 and the processor 404 may interact with each other so as to perform the operations of the node described in any of FIGS. 1-3.

In some embodiments of the present disclosure, the apparatus 400 may further include at least one non-transitory computer-readable medium.

For example, in some embodiments of the present disclosure, the non-transitory computer-readable medium may have stored thereon computer-executable instructions to cause the processor 404 to implement the method with respect to the UE as described above. For example, the computer-executable instructions, when executed, cause the processor 404 interacting with transceiver 402 to perform the operations of the UE described in any of FIGS. 1-3.

In some embodiments of the present disclosure, the non-transitory computer-readable medium may have stored thereon computer-executable instructions to cause the processor 404 to implement the method with respect to the node as described above. For example, the computer-executable instructions, when executed, cause the processor 404 interacting with transceiver 402 to perform the operations of the node described in any of FIGS. 1-3.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory and
at least one processor coupled with the at least one memory and configured to cause the UE to:
receive information scheduling or activating a physical uplink shared channel (PUSCH), wherein the PUSCH is configured with a plurality of repetitions being frequency multiplexed, and each repetition of the plurality of repetitions is associated with a beam of a plurality of beams; and
transmit uplink control information (UCI) on at least one repetition of the plurality of repetitions of the PUSCH transmission, wherein, when the UCI is transmitted on at least two repetitions of the plurality of repetitions, a total number of coded bits of the UCI on each of the at least two repetitions is identical.

2. The UE of claim 1, wherein, when the UCI only includes channel state information (CSI) reporting, the UCI is transmitted on at least two repetitions of the plurality of repetitions.

3. The UE of claim 2, wherein, when the UCI at least includes a type of UCI different from CSI reporting, the UCI is transmitted on one repetition of the plurality of repetitions, including:
a repetition with a largest number of resource blocks (RBs) among the plurality of repetitions;
a repetition with a smallest number of RBs among the plurality of repetitions;
a repetition associated with a first beam among the plurality of beams;
a repetition associated with a last beam among the plurality of beams;
a repetition associated with a lowest starting RB index among the plurality of repetitions; or
a repetition associated with a highest starting RB index among the plurality of repetitions.

4. The UE of claim 1, wherein the UCI is transmitted on the at least two repetitions of the plurality of repetitions regardless of whether CSI reporting is included in the UCI.

5. The UE of claim 1, wherein, when the UCI is transmitted on at least two repetitions of the plurality of repetitions, the at least one processor is further configured to cause the UE to:
determine the total number of coded bits of the UCI of each of the at least two repetitions based on a total number of resource blocks (RBs) of each of the at least two repetitions and a total number of phase tracking reference signal (PT-RS) ports of each of the at least two repetitions, wherein the total number of RBs of each repetition of the at least two repetitions is identical, and the total number of PT-RS ports of each repetition of the at least two repetitions is identical.

6. The UE of claim 1, wherein, when the UCI is transmitted on at least two repetitions of the plurality of repetitions, the at least one processor is further configured to cause the UE to:
determine the total number of coded bits of the UCI of each of the at least two repetitions based on a total number of resource blocks (RBs) of a repetition of the plurality of repetitions and a total number of phase tracking reference signal (PT-RS) resource elements (REs) of a repetition of the plurality of repetitions, including:
a repetition with a largest number of RBs among the plurality of repetitions;
a repetition with a smallest number of RBs among the plurality of repetitions;
a repetition associated with a first beam among the plurality of beams;
a repetition associated with a last beam among the plurality of beams;
a repetition associated with a lowest starting RB index among the plurality of repetitions; or
a repetition associated with a highest starting RB index among the plurality of repetitions.

7. A Base Station (BS) for wireless communication, comprising:
at least one memory; and
at least one processor coupled with the at least one memory and configured to cause the BS to:
transmit information scheduling or activating a physical uplink shared channel (PUSCH), wherein the PUSCH is configured with a plurality of repetitions being frequency multiplexed, and each repetition of the plurality of repetitions is associated with a beam of a plurality of beams; and
receive uplink control information (UCI) on at least one repetition of the plurality of repetitions of the PUSCH transmission, wherein in the case that the UCI is received on at least two repetitions of the plurality of repetitions, a total number of coded bits of the UCI on each of the at least two repetitions is identical.

8. The BS of claim 7, wherein, when the UCI only includes a channel state information (CSI) reporting, the UCI is received on at least two repetitions of the plurality of repetitions.

9. The BS of claim 8, wherein, when the UCI at least includes a type of UCI different from CSI reporting, the UCI is received on one repetition of the plurality of repetitions, including:
a repetition with a largest number of RBs among the plurality of repetitions;
a repetition with a smallest number of RBs among the plurality of repetitions;
a repetition associated with a first beam among the plurality of beams;
a repetition associated with a last beam among the plurality of beams;
a repetition associated with a lowest starting resource block (RB) index among the plurality of repetitions; or
a repetition associated with a highest starting RB index among the plurality of repetitions.

10. The BS of claim 7, wherein the UCI is received on the at least two repetitions of the plurality of repetitions regardless of whether CSI reporting is included in the UCI.

11. The BS of claim 7, wherein, when the UCI is received on at least two repetitions of the plurality of repetitions, the at least one processor is further configured to cause the BS to:
determine the total number of coded bits of the UCI of each of the at least two repetitions based on a total number of resource blocks (RBs) of each of the at least two repetitions and a total number of phase tracking reference signal (PT-RS) ports of each of the at least two repetitions, wherein the total number of RBs of each repetition of the at least two repetitions is identical, and the total number of PT-RS ports of each repetition of the at least two repetitions is identical.

12. The BS of claim 7, wherein, when the UCI is received on at least two repetitions of the plurality of repetitions, the processor is further configured to:
determine the total number of coded bits of the UCI of each of the at least two repetitions based on a total number of resource blocks (RBs) of a repetition of the plurality of repetitions and a total number of phase tracking reference signal (PT-RS) resource elements (REs) of a repetition of the plurality of repetitions as the following:
a repetition with a largest number of RBs among the plurality of repetitions;
a repetition with a smallest number of RBs among the plurality of repetitions;
a repetition associated with a first beam among the plurality of beams;
a repetition associated with a last beam among the plurality of beams;
a repetition associated with a lowest starting RB index among the plurality of repetitions; or
a repetition associated with a highest starting RB index among the plurality of repetitions.

13. A method performed by a user equipment (UE), the method comprising:
receiving information scheduling or activating a physical uplink shared channel (PUSCH), wherein the PUSCH is configured with a plurality of repetitions being frequency multiplexed, and each repetition of the plurality of repetitions is associated with a beam of a plurality of beams; and
transmitting uplink control information (UCI) on at least one repetition of the plurality of repetitions of the PUSCH transmission, wherein in the case that the UCI is transmitted on at least two repetitions of the plurality of repetitions, a total number of coded bits of the UCI on each of the at least two repetitions is identical.

14. The method of claim 13, wherein, when the UCI only includes channel state information (CSI) reporting, the UCI is transmitted on at least two repetitions of the plurality of repetitions.

15. The method of claim 14, wherein, when the UCI at least includes a type of UCI different from CSI reporting, the UCI is transmitted on one repetition of the plurality of repetitions, including:
a repetition with a largest number of resource blocks (RBs) among the plurality of repetitions;
a repetition with a smallest number of RBs among the plurality of repetitions;
a repetition associated with a first beam among the plurality of beams;
a repetition associated with a last beam among the plurality of beams;
a repetition associated with a lowest starting RB index among the plurality of repetitions; or
a repetition associated with a highest starting RB index among the plurality of repetitions.

16. The method of claim 13, wherein the UCI is transmitted on the at least two repetitions of the plurality of repetitions regardless of whether CSI reporting is included in the UCI.

17. The method of claim 13, wherein, when the UCI is transmitted on at least two repetitions of the plurality of repetitions, the method further comprises:
determining the total number of coded bits of the UCI of each of the at least two repetitions based on a total number of resource blocks (RBs) of each of the at least two repetitions and a total number of phase tracking reference signal (PT-RS) ports of each of the at least two repetitions, wherein the total number of RBs of each repetition of the at least two repetitions is identical, and the total number of PT-RS ports of each repetition of the at least two repetitions is identical.

18. The method of claim 13, wherein, when the UCI is transmitted on at least two repetitions of the plurality of repetitions, the method further comprises:
determining the total number of coded bits of the UCI of each of the at least two repetitions based on a total number of resource blocks (RBs) of a repetition of the plurality of repetitions and a total number of phase tracking reference signal (PT-RS) resource elements (REs) of a repetition of the plurality of repetitions, including:
a repetition with a largest number of RBs among the plurality of repetitions;
a repetition with a smallest number of RBs among the plurality of repetitions;
a repetition associated with a first beam among the plurality of beams;
a repetition associated with a last beam among the plurality of beams;
a repetition associated with a lowest starting RB index among the plurality of repetitions; or
a repetition associated with a highest starting RB index among the plurality of repetitions.

19. A processor for wireless communication, comprising:
at least one controller coupled with the at least one memory and configured to cause the processor to:
receive information scheduling or activating a physical uplink shared channel (PUSCH), wherein the PUSCH is configured with a plurality of repetitions being frequency multiplexed, and each repetition of the plurality of repetitions is associated with a beam of a plurality of beams; and
transmit uplink control information (UCI) on at least one repetition of the plurality of repetitions of the PUSCH transmission, wherein, when the UCI is transmitted on at least two repetitions of the plurality of repetitions, a total number of coded bits of the UCI on each of the at least two repetitions is identical.

20. The processor of claim 19, wherein, when the UCI only includes channel state information (CSI) reporting, the UCI is transmitted on at least two repetitions of the plurality of repetitions.
